(19) United States
(12) Patent Application Publication
(10) Pub. No.: US 2007/0139940 A1
(43) Pub. Date: Jun. 21, 2007

(54) Front end module carrier for vehicle

(75) Inventors: Sung Hoon Jung, Yongin-shi (KR); Se Hwan Kim, Suwon-shi (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Yongin-shi (KR)

(21) Appl. No.: 11/436,513

(22) Filed: May 19, 2006

(30) Foreign Application Priority Data
Dec. 15, 2005 (KR) 10-2005-0123950

(51) Int. Cl. G01B 13/18

(52) U.S. Cl. 362/460

(57) ABSTRACT

A front end module carrier for a vehicle includes a metal frame; and a plastic molding injection-molded into the metal frame. The metal frame includes an upper frame portion, a lower frame portion, and left and right side frame portions having upper ends connected to respective right and left sides of the upper frame portion and lower ends connected to respective right and left sides of the lower frame portion, wherein the metal frame is formed unitarily and in one-piece.

### BACKGROUND OF THE INVENTION

1. Field of the Invention

The present invention relates to a front end module carrier for a vehicle, and more particularly to a front end module carrier for a vehicle capable of reducing the number of molds used to manufacture a metal frame and simplifying a manufacturing process of the carrier as the metal frame is formed integrally with the carrier.

2. Background of the Related Art

In general, a front end module is a structure whose parts of constituting a front end of a vehicle are modularized, and this has an advantage to be capable of reducing greatly the number of parts and assemblers and of installing the front end module in a frame of the vehicle by a single process.

The front end module includes a carrier for fixing air conditioner's condenser for a vehicle, radiator and the like thereto and mounting a bumper therein for protecting the vehicle body and passengers from forward impacts of the vehicle body.

In the recent years, as vehicles are requested to be light-weighted, carriers are made of plastic materials, and particularly hybrid-type carriers have a tendency to be widely employed which use metal members together with the plastic materials for enhancing the entire strength.

FIG. 1 is a front view showing a front end module carrier for a vehicle according to the prior art, FIG. 2 is a sectional view taken along line A-A of FIG. 1, and FIG. 3 is a exploded perspective view showing a metal frame of a carrier according to the prior art.

The front end module carrier for the vehicle according to the prior art, as shown in FIGS. 1 to 3, has a configuration that a metal frame 20 separated into plural members is insert-molded into a plastic molding 10.

The plastic molding 10 is formed by injecting and curing a fused plastic into an injection mold (not shown) formed with a cavity having the same shape as the carrier 1, with the metal frame 20 inserted within the injection mold.

The metal frame 20 includes an upper frame portion 22 arranged in an upper side of the plastic molding 10, a lower frame portion 24 arranged in a lower portion of the plastic molding 10 to be parallel with the upper frame portion 22, side frame portions 26 arranged in left and right sides of the plastic molding 10 so that their upper and lower sides are overlapped to the upper frame portion 22 and lower frame portion 24, respectively, and a center frame portion 28 arranged such that its upper and lower sides are overlapped in the mid-portion of the upper frame portion 22 and lower frame portion 24, respectively.

A mounting frame portion 30 for mounting head lamps (not shown) for the vehicle is formed integrally with and extended from the right and left ends of the upper frame portion 22.

In particular, since the metal frame 20 is arranged such that the upper frame portion 22 and lower frame portion 24 are overlapped to the upper and lower sides of the side frame portions 26 and center frame portion 28, the plastic molding 10 is formed relatively thicker in overlapped portions 32 than in the other portions, so that the overlapped portions 32 may be stably connected.

However, since the upper frame portion 22, lower frame portion 24, side frame portions 26 and center frame portion 28 are separately manufactured through a press working in the front end module carrier for the vehicle according to the prior art as described above, at least 5 or more press molds and 5 or more industrial robots used for inserting parts of the metal frame 20 into the injection molds are needed to manufacture the metal frame 20.

That is, the prior carrier 1 has a problem in that as the number of parts constituting the metal frame 20 increases, the number of press molds and the industrial robots also increases.

The increase of the number of press molds and industrial robots causes the investment cost to be higher and the injection process to be complicated. Moreover, this leads to the increase of the number of process and manufacturing time due to a lowering of workability during the injection process. Furthermore, since the amount of using the metal frame 20 and the plastic injection molding 10 increases due to the overlapped portions 32 of the metal frame 20, the weight and material cost of the carrier 1 increase and there occurs a dimensional instability because of the flow of the overlapped portions 32 of the metal frame 20.

### SUMMARY OF THE INVENTION

The present invention has been designed to solve the aforementioned problems occurring in the prior art. The present provides a front end module carrier for a vehicle capable of reducing the investment cost, the number of manufacturing processes, and manufacturing time for the carrier since the number of molds for a metal frame and industrial robots can be reduced by forming an integral metal frame.

In addition, the present invention provides a front end module carrier for a vehicle capable of reducing weight and material cost of the carrier and mitigating the dimensional instability due to the overlapped portions by eliminating the overlapped portions of a metal frame.

To solve the problems, a front end module carrier for a vehicle according to the present invention includes a metal frame comprising an upper frame portion, side frame portions whose upper sides are integrally connected to the right and left sides of the upper frame portion, and a lower frame portion whose right and left sides are integrally connected to the lower sides of the side frame portions; and a plastic molding injection-molded into the metal frame.

The metal frame further includes mounting frame portions formed integrally with right and left ends of the upper frame portion, respectively, for installing head lamps.

In addition, the metal frame may further include mounting frame portions insert-injected into right and left ends of the upper frame portion, respectively, for installing head lamps.

In addition, the plastic molding may include mounting portions injection-molded into right and left ends of the upper frame portion, for installing head lamps.

And, the metal frame further includes a center frame portion whose upper and lower sides are integrally connected in the mid-portion of the upper frame portion and lower frame portion, respectively.

In addition, the plastic molding may include a center portion injection-molded to connect vertically between mid-portions of the upper frame portion and lower frame portion.

### BRIEF DESCRIPTION OF THE DRAWINGS

FIG. 1 is a front view showing a front end module carrier for a vehicle according to the prior art.

FIG. 2 is a sectional view taken along line A-A of FIG. 1.

FIG. 3 is a exploded perspective view showing a metal frame of a carrier according to the prior art.

FIG. 4 is a front view showing a front end module carrier for a vehicle according to a first embodiment of the present invention.

FIG. 5 is a sectional view taken along line B-B of FIG. 4.

FIG. 6 is a front view showing a metal frame of a carrier according to a first embodiment of the present invention.

FIG. 7 is a front view showing a metal frame of a carrier according to a second embodiment of the present invention.

FIG. 8 is a front view showing a front end module carrier for a vehicle according to a third embodiment of the present invention.

FIG. 9 is a front view showing a metal frame of a carrier according to a third embodiment of the present invention.

FIG. 10 is a front view showing a front end module carrier for a vehicle according to a fourth embodiment of the present invention.

FIG. 11 is an exploded perspective view showing a metal frame of a carrier according to a fourth embodiment of the present invention.

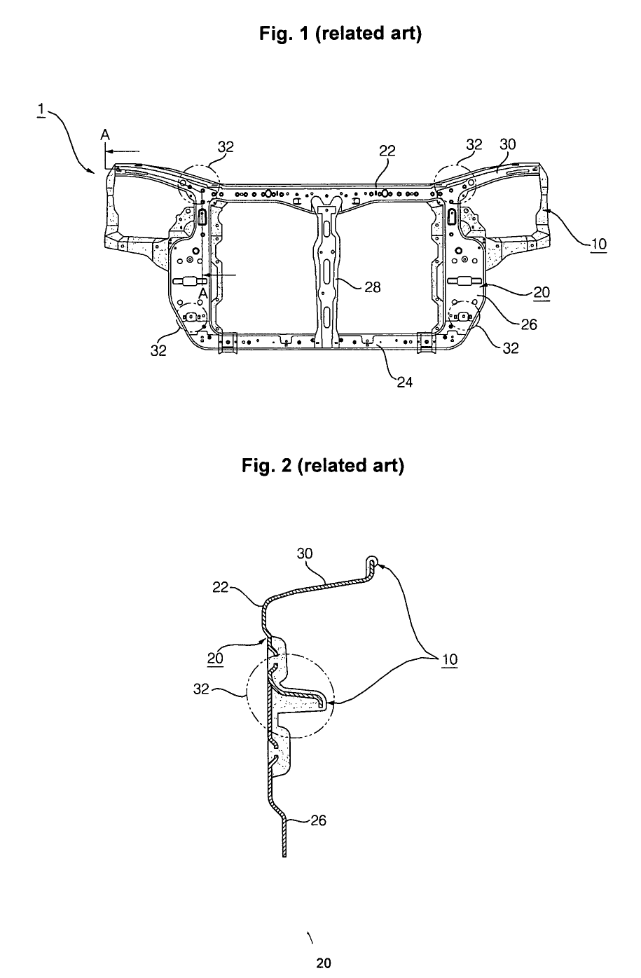

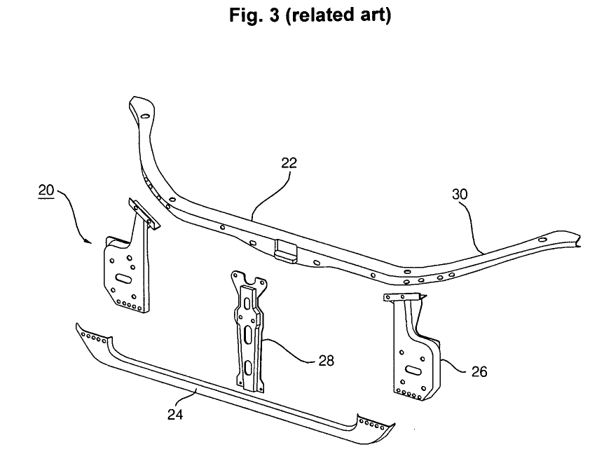

### DESCRIPTION OF THE PREFERRED EMBODIMENTS

Hereafter, desirable embodiments of the present invention will be described in a more detailed manner with reference to the accompanying drawings.

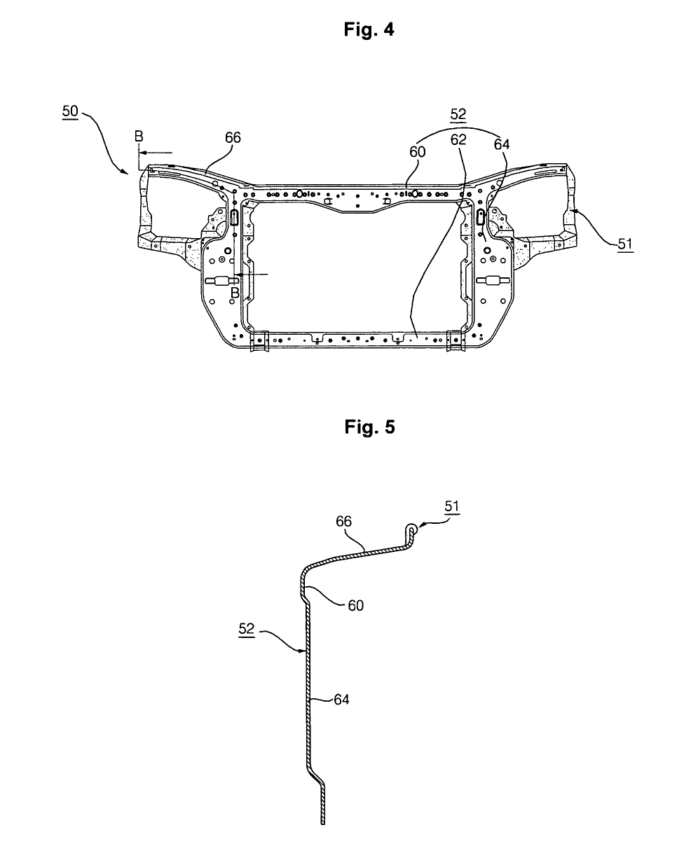

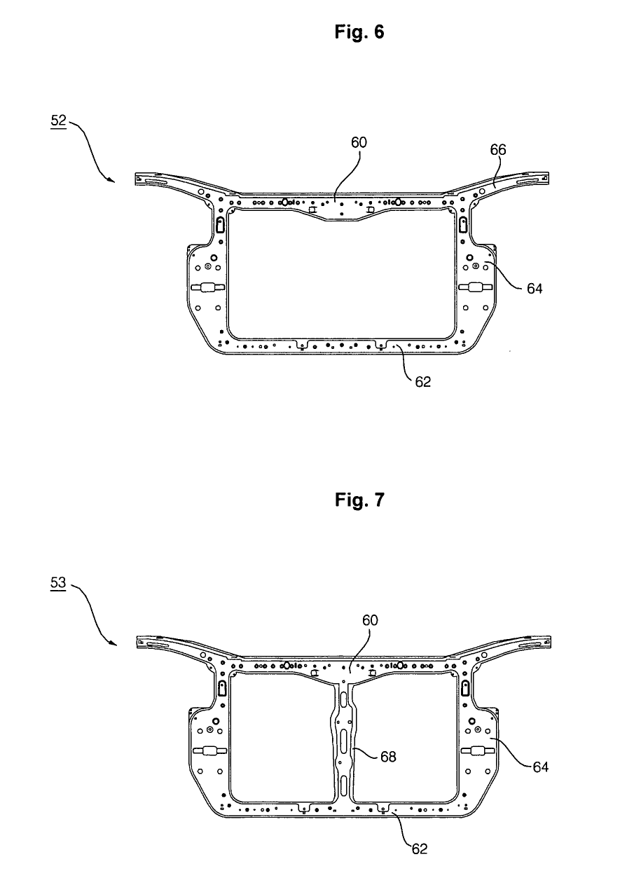

FIG. 4 is a front view showing a front end module carrier for a vehicle according to a first embodiment of the present invention, FIG. 5 is a sectional view taken along line B-B of FIG. 4, and FIG. 6 is a front view showing a metal frame of a carrier according to a first embodiment of the present invention.

A front end module carrier for a vehicle according to a first embodiment of the present invention, as shown in FIGS. 4 to 6, includes a plastic molding 51 formed of a plastic material and a metallic metal frame 52 insert-injected into the plastic molding 51.

The plastic molding 51 is formed by injecting and curing a fused plastic into an injection mold (not shown) formed with a cavity having the same shape as the carrier 50, with the metal frame 52 inserted within the injection mold in advance to reinforce the strength of the carrier 50.

Therefore, the carrier 50 is configured in the hybrid type which uses both the plastic and the metal by employing the metal frame 52 and plastic molding 51.

The metal frame 52 includes an upper frame portion 60 arranged in an upper side of the plastic molding 51, a lower frame portion 62 arranged in a lower side of the plastic molding 51 to be parallel with the lower side of the upper frame portion 60, side frame portions 64 arranged in left and right sides of the plastic molding 51 so that their upper and lower sides are integrally connected to the upper frame portion 60 and lower frame portion 62, respectively.

That is, the metal frame 52 is a metallic frame formed by a sheet metal processing in the shape of ‘□’, and the upper frame portion 60, lower frame portion 62, and side frame portions 64 are integrally formed by a single press working from a press machine.

As such, the metal frame 52 is formed so that the upper frame portion 60, lower frame portion 62, and side frame portions 64 fail to constitute overlapping portions in the connections therebetween.

The upper frame portion 60 constitutes an upper side of the metal frame 52 and extends long in the right and left directions to mount an upper side of a radiator (not shown), and in right and left ends of the upper frame portion 60 are formed mounting frame portions 66 to extend long in the back to install a head lamp (not shown).

The lower frame portion 62 extends long in the right and left directions to constitute a lower side of the metal frame 52 and is arranged to be parallel with the upper frame portion 60 at the location spaced from the upper frame portion 60 to the lower side by a predetermined interval.

The side frame portions 64 extends long in the upper and lower directions to form left and right sides of the metal frame 52 and their upper sides are each integrally connected to the right and left sides of the upper frame portion 60 and similarly their lower sides are each integrally connected to the right and left sides of the lower frame portion 62.

A manufacturing procedure and operational effects will now be described below with respect to a front end module carrier for a vehicle constructed as above according to a first embodiment of the present invention.

Firstly, a metal sheet with a predetermined thickness is placed on a press mold of a press machine and the press mold performs a press working of the metal sheet to thereby form a metal frame 52.

As such, since the metal frame 52 may be formed through a single press working, only one press mold is used for the metal frame 52 and the number of processes for the metal frame 52 can also be lessened greatly.

In particular, the metal frame 52 is manufactured with a single press mold and this can save the enormous facility investment costs for press working of the metal frame 52 in comparison with the prior art.

As the metal frame 52 manufactured as above is inserted into an injection mold having a cavity of the same shape as a carrier 50 and a fused plastic is injected and then cooled into the injection mold, a hybrid type carrier 50 is completed.

At this time, as the metal frame 52 is accommodated in a lower mold of the injection mold by a industrial robot and the lower mold is brought in intimate contact with an upper mold of the injection mold, then the fused plastic is injected into the injection mold.

As such, since the work of inserting the metal frame 52 into the injection mold is performed by a single industrial robot, the number of industrial robots used may be reduced and this allows for decreasing the facility investment cost needed to injection-mold the plastic molding 51. And, the number of the industrial robot's operations is decreased and this can reduce the number of injection processes of the plastic molding 51.

Since the carrier 50 manufactured through the above procedure doesn't include the overlapped portions in the metal frame 52 in contrast to the prior art, it can be possible to prevent material cost and weight due to the overlapped portions of the metal frame 52 from rising, to get rid of dimension instability from the flow of the overlapped portions and dimensional tolerance, and to prevent the increase of the amount of the injection molding 51 used to connect the overlapped portions of the metal frame 52 stably.

FIG. 7 is a front view showing a metal frame of a carrier according to a second embodiment of the present invention.

For reference, the identical parts are labeled by the same reference numerals as in the first embodiment and those identical parts will not be described in detail.

A front end module carrier for a vehicle according to a second embodiment of the present invention, as shown in FIG. 7, is formed by insert injection of a metal frame 53 formed integrally with a plastic molding 51 wherein the metal frame 53 includes an upper frame portion 60, a lower frame portion 62 arranged in parallel with the upper frame portion 60 in the lower side of the upper frame portion 60, side frame portions 64 arranged in the right and left ends of the plastic molding 51, respectively, so that their upper and lower sides are each integrally connected to the upper frame portion 60 and lower frame portion 62, and a center frame portion 68 arranged between the upper frame portion 60 and lower frame portion 62 so that its upper and lower sides are each integrally connected in the mid-portion of the upper frame portion 60 and lower frame portion 62.

That is, the metal frame 53 is press-worked by a press machine, and the upper frame portion 60, lower frame portion 62, side frame portions 64, and center frame portion 68 are all formed integrally by a single press working from a press machine.

As such, since in the second embodiment of the present invention, the center frame portion 68 extends long in the upper and lower directions between the side frame portions 64 arranged in the right and left sides of the metal frame 53, it supports the mid-portions of the upper frame portion 60 and lower frame portion 62, thus enhancing the structural strength.

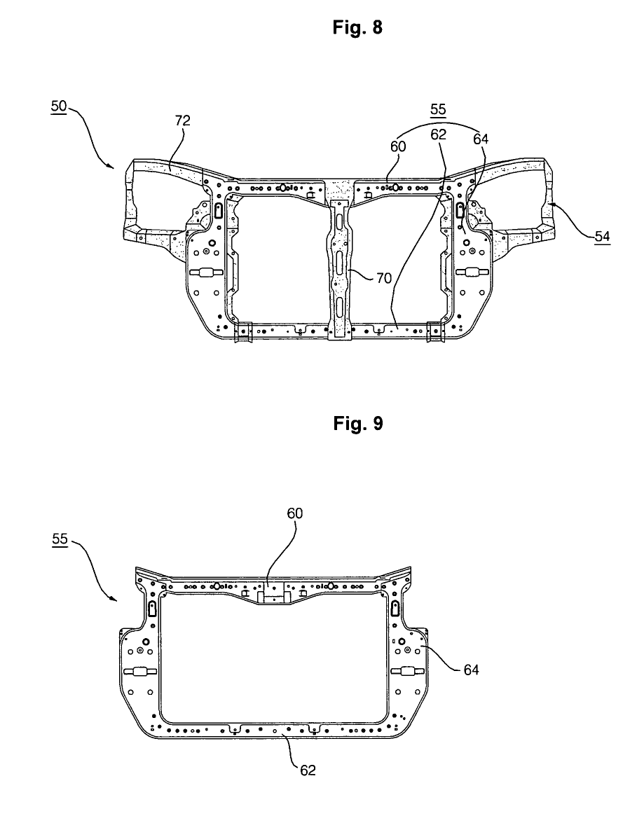

FIG. 8 is a front view showing a front end module carrier for a vehicle according to a third embodiment of the present invention, and FIG. 9 is a front view showing a metal frame of a carrier according to a third embodiment of the present invention.

For reference, the identical parts are labeled by the same reference numerals as in the first embodiment and those identical parts will not be described in detail.

A front end module carrier for a vehicle according to a third embodiment of the present invention, as shown in FIGS. 8 and 9, a plastic molding 54 is formed by insert injection of a metal frame 55 formed integrally with a plastic molding 54, and the plastic molding 54 further includes a mounting portion 72 injection-molded for installing head lamps in the right and left sides of the metal frame 55 and a center portion 70 injection-molded for reinforcing the strength of the mid-portion of the metal frame 55, and the other constructions are the same as the first embodiment of the present invention.

The metal frame 55 includes an upper frame portion 60 arranged in an upper side of the plastic molding 54, a lower frame portion 62 arranged in a lower side of the plastic molding 54 to be parallel with the lower side of the upper frame portion 60, side frame portions 64 arranged in left and right sides of the plastic molding 54 so that their upper and lower sides are integrally connected to the upper frame portion 60 and lower frame portion 62, respectively.

The mounting portion 72 is injection-molded to project from the right and left ends of the metal frame 55, respectively, and extended to decline from the metal frame 55 to the back at a predetermined angle.

The center portion 70 is injection-molded long in the upper and lower directions between the side frame portions 64 arranged in the right and left sides of the metal frame 53 so that their upper and lower sides are each integrally connected in the mid-portion of the upper frame portion 60 and lower frame portion 62.

As such, in the third embodiment of the present invention, the center portion 70 supports the mid-portions of the upper frame portion 60 and lower frame portion 62, thus enhancing the structural strength of the carrier 50 and making it possible to simplify forming the mounting portion 72 and center portion 70 in an injection molding method.

In particular, the third embodiment of the present invention can be usefully used to manufacture a carrier 50 with a portion extending long to the back where head lamps are formed in the right and left sides of the metal frame portion 55.

That is, since the carrier 50 with the portion of installing head lamps extending long to the back is very difficult to form a metal frame formed integrally with the mounting frame directly by a single press mold as in the first embodiment of the present invention, the mounting frame portion 72 having a desired shape is injection-molded in the right and left sides of the metal frame with the metal frame portion omitted as in the third embodiment of the present invention.

Therefore, the freedom degree of design is highly improved.

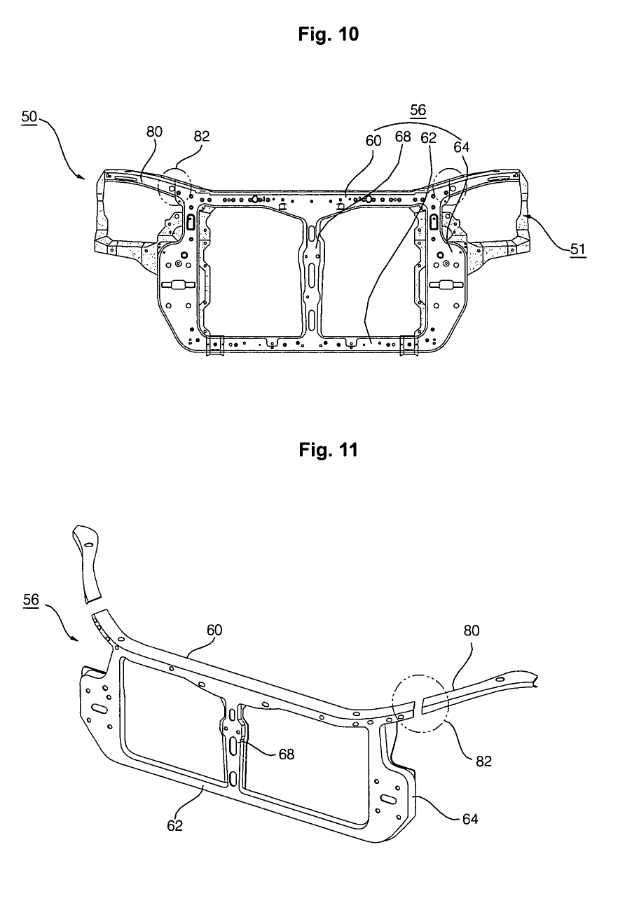

FIG. 10 is a front view showing a front end module carrier for a vehicle according to a fourth embodiment of the present invention, and FIG. 11 is an exploded perspective view showing a metal frame of a carrier according to a fourth embodiment of the present invention.

For reference, the identical parts are labeled by the same reference numerals as in the first embodiment and those identical parts will not be described in detail.

A front end module carrier for a vehicle according to a fourth embodiment of the present invention, as shown in FIGS. 10 and 11, is formed by insert injection of a metal frame 56 formed integrally with a plastic molding 51 wherein the metal frame 56 includes an upper frame portion 60, a lower frame portion 62 arranged in parallel with the upper frame portion 60 in the lower side of the upper frame portion 60, side frame portions 64 arranged in the right and left sides of the plastic molding 51, respectively, so that their upper and lower sides are each integrally connected to the upper frame portion 60 and lower frame portion 62, and a center frame portion 68 arranged between the upper frame portion 60 and lower frame portion 62 so that its upper and lower sides are each integrally connected in the mid-portion of the upper frame portion 60 and lower frame portion 62, with a mounting frame portion 80 insert-injected into the plastic molding 51 in the right and left ends of the upper frame portion 60 for installing head lamps (not shown), and the other constructions are the same as the first embodiment.

That is, the metal frame 56 is press-worked by a press machine and the upper frame portion 60, lower frame portion 62, side frame portions 64, and center frame portion 68 are formed integrally by a single press working from a press machine.

As such, since in the fourth embodiment of the present invention, the center frame portion 68 extends long in the upper and lower directions between the side frame portions 64 arranged in the right and left sides of the metal frame 56, it supports the mid-portions of the upper frame portion 60 and lower frame portion 62, thus enhancing the structural strength of the metal frame 56.

Further, since in a case where the portions for installing head lamps in the carrier 50 have a construction to extend long to the back from the right and left sides of the metal frame 56, it is difficult to form the metal frame integrally formed with the mounting frame 80 directly by a single press mold as in the first embodiment and thus, in the fourth embodiment of the present invention, the mounting frame 80 is manufactured separately from the metal frame 56 and then is insert-injected into the plastic molding 51.

As described above, in the carrier 50 with the portions for installing head lamps extended long to the back, the mounting frame portion 80 is connected to the right and left sides of the metal frame by the plastic molding 51.

Of course, it is desirable that the mounting frame portion 80 and upper frame portion 60 are arranged to be overlapped to each other in the connections thereof and the injected plastic molding 51 are formed thicker in the overlapped portions 82.

Therefore, in the fourth embodiment of the present invention, the number of overlapped portions of the metal frame 56 is lessened in comparison to the prior art and this allows for reducing the material cost of the metal frame 56 and plastic molding 51, thus improving greatly the freedom degree of design of the carrier 50.

Although a front end module carrier for a vehicle according to the present invention is described with reference to the exemplary drawings, the invention is not limited to the embodiments and drawings set forth herein, rather it is limited only to the accompanying claims and many alternatives, modifications, and variations will be apparent to those skilled in the art.

That is, the metal frame of the present invention can be integrally formed not only by a press working method of a press machine but also by a casting method of a casting machine.

In addition, the metal frame of the present invention, if desired, can be formed while any one part thereof is separated.

As mentioned above, since in the front end module of a vehicle according to the present invention, the upper frame portion, lower frame portion and side frame portions of the metal frame are all formed integrally, the number of molds for manufacturing the metal frame and the industrial robots for inserting the metal frame into the injection mold can be decreased.

In addition, the decrease of the number of the molds and industrial robots allows for saving the facility investment cost to manufacture the carrier and lessening the number of manufacturing processes of the metal frame and injection processes for the plastic molding.

In addition, since the number of the manufacturing processes of the carrier is reduced entirely, the manufacturing time can be reduced and the manufacturing process can also be very simplified.

In addition, since the metal frame is integrally formed and thus the overlapped portions can be eliminated in contrast to the prior art, the increase of weight and material cost due to the overlapped portions of the metal frame can be prevented and dimensional instability from the flow of the overlapped portions can be mitigated.

What is claimed is:

1. A front end module carrier for a vehicle comprising:
a metal frame, including an upper frame portion, a lower frame portion, and left and right side frame portions having upper ends connected to respective right and left sides of the upper frame portion and lower ends connected to respective right and left sides of the lower frame portion; and
a plastic molding injection-molded into the metal frame,
wherein the metal frame is formed unitarily and in one-piece.

2. The front end module carrier for a vehicle as claimed in claim 1, wherein the metal frame further comprises mounting frame portions formed unitarily and in one-piece with right and left ends of the upper frame portion, respectively, to install head lamps.

3. The front end module carrier for a vehicle as claimed in claim 1, wherein the metal frame further comprises mounting frame portions insert-injected onto right and left ends of the upper frame portion, respectively, to install head lamps.

4. The front end module carrier for a vehicle as claimed in claim 1, wherein the plastic molding comprises mounting portions injection-molded onto right and left ends of the upper frame portion, respectively, to install head lamps.

5. The front end module carrier for a vehicle as claimed in claim 1, wherein the metal frame further comprises a center frame portion formed unitarily and in one-piece with mid-portions of the upper frame portion and lower frame portion.

6. The front end module carrier for a vehicle as claimed in claim 5, wherein the metal frame further comprises mounting frame portions formed unitarily and in one-piece with right and left ends of the upper frame portion, respectively, to install head lamps.

7. The front end module carrier for a vehicle as claimed in claim 5, wherein the metal frame further comprises mounting frame portions insert-injected onto right and left ends of the upper frame portion, respectively, to install head lamps.

8. The front end module carrier for a vehicle as claimed in claim 5, wherein the plastic molding comprises mounting portions injection-molded onto right and left ends of the upper frame portion, respectively, to install head lamps.

9. The front end module carrier for the vehicle as claimed in claim 1, wherein the metal frame further comprises a center portion injection-molded to connect mid-portions of the upper frame portion and lower frame portion vertically.

10. The front end module carrier for the vehicle as claimed in claim 9, wherein the metal frame further comprises mounting frame portions formed unitarily and in one-piece with right and left ends of the upper frame portion, respectively, to install head lamps.

11. The front end module carrier for the vehicle as claimed in claim 9, wherein the metal frame further comprises mounting frame portions insert-injected onto right and left ends of the upper frame portion, respectively, to install head lamps.

12. The front end module carrier for the vehicle as claimed in claim 9, wherein the plastic molding comprises mounting portions injection-molded onto right and left ends of the upper frame portion, respectively, to install head lamps.

13. A front end module carrier for a vehicle, the front end module carrier including a metal frame insert-injected into a plastic molding, wherein the metal frame is formed unitarily and in one-piece.
